(19) United States
(12) Patent Application Publication
(10) Pub. No.: US 2021/0371278 A1
(43) Pub. Date: Dec. 2, 2021

(54) SYNERGIES OF A NATURAL GAS LIQUEFACTION PROCESS IN A SYNTHESIS GAS PRODUCTION PROCESS

(71) Applicant: L'Air Liquide, Société Anonyme pour I'Etude et I'Exploitation des Procédés Georges Claude, Paris (FR)

(72) Inventors: Pierre COSTA DE BEAUREGARD, Issy les Moulineaux (FR); Pascal MARTY, Bry sur Marne (FR); Thomas MOREL, Noisy le Grand (FR)

(21) Appl. No.: 16/970,143

(22) PCT Filed: Feb. 16, 2018
(86) PCT No.: PCT/FR2018/050381

§ 371 Date: Aug. 14, 2020

(51) Int. Cl. C01B 3/34; C10L 3/10; F25J 1/00

(52) U.S. Cl. CPC C01B 3/34; C10L 3/103; C10L 3/105; C10L 3/106; C10L 2290/541; C01B 2203/0233; C01B 2203/1241; C01B 2203/127; C10L 2290/542; F25J 1/0022

(57) ABSTRACT

A natural gas liquefaction process combined with a synthesis gas production process. At least one part of the heat source required in the synthesis gas production process is provided by at least a portion of the regeneration stream utilized to pretreat the natural gas to be liquefied.

### CROSS REFERENCE TO RELATED APPLICATIONS

This application is a 371 of International Application PCT/FR2018/050381, filed Feb. 16, 2018, the entire contents of which are incorporated herein by reference.

### BACKGROUND

The present invention relates to a process for the liquefaction of a stream of hydrocarbons, such as natural gas, in combination with a process for the production of synthesis gas.

The invention relates to the integration of a process for the liquefaction of natural gas in a process for the production of synthesis gas by superheated steam reforming, partial oxidation or autothermal reforming.

These technologies for the production of synthesis gas sometimes require the use of large amounts of natural gas which are used as feed stream but also as source of heating for the process.

It is also desirable to liquefy natural gas for a certain number of reasons. By way of example, natural gas can be stored and transported over long distances more easily in the liquid state than in the gas form, since it occupies a smaller volume for a given weight and does not need to be stored at a high pressure.

Processes for the generation of synthesis gas generally have, as finished products, hydrogen, carbon monoxide or a mixture of the two (known as oxogas), indeed even an H₂/CO/CO₂ mixture (production of methanol) or a N₂/H₂ mixture (production of ammonia). Each of these processes additionally cogenerates more or less superheated steam.

After a metering and optionally compression or decompression unit, the production of synthesis gas generally includes the following stages:

1. A hot desulfurization stage: after a preheating (350-400° C.), all the sulfur-comprising derivatives present in the natural gas are converted into H₂S by catalysis in a hydrogenation (CoMox) reactor. The H₂S is then removed by catalysis (over a ZnO bed, for example).

2. An optional prereforming stage (stage mainly present in the steam reforming units): at high temperature (approximately 500-550° C.) with excess steam, Then, in the presence of catalyst: conversion of the hydrocarbon chains containing at least two carbon atoms into methane with coproduction of carbon monoxide, carbon dioxide (CO₂) and hydrogen.

3. Reforming stage, which consists in reacting, at high temperature (850-950° C.), the hydrocarbons with steam in order to produce hydrogen, CO and CO₂.

Downstream of the units for the production of synthesis gas, the products generally recycled are carbon monoxide (CO), hydrogen (H₂) or an H₂/CO mixture.

If appropriate, the final stage of the process for the production of synthesis gas can also be a:
Stage of partial oxidation over a catalytic bed (autothermal reformer), which consists in reacting the oxygen with the hydrocarbons at high temperature (800-1200° C.) in order to produce more CO;
A stage of conversion of CO into H₂ in a catalytic reactor in the case of an exhaustive production of hydrogen;

The purification of the synthesis gas produced can then be carried out either by:
Use of a PSA in order to purify the hydrogen-rich stream produced; or
Scrubbing with amines in order to extract the CO₂ from the synthesis gas in the cases of production of CO or oxogas; and
Purification in a cold box of the CO-rich stream produced; or
Passing the gas produced through a membrane in order to adjust the H₂/CO ratio required for the quality of the oxogas to be produced.

The synthesis gas production units generally require a constant supply of heat provided by a fuel system. This fuel consists completely or partly of natural gas, but also of available hydrocarbon-rich streams such as, for example, those discharged by units placed downstream of the synthesis gas production unit (Off Gas PSA, stream rich in methane or rich in hydrogen at the outlet of the cold box, etc.) or the industrial site.

It is necessary to ensure that the fuel balance is balanced, This means that all of the heat energy contained in the streams discharged to the fuel system must not exceed the heat requirements of the synthesis gas production unit and possibly of other units located nearby sharing the same fuel network.

Otherwise, all or some of certain streams discharged to the fuel system would have to be sent back continuously to a flare, which is not acceptable in particular for atmospheric emission constraints.

Furthermore, in a general way, the units for liquefaction of natural gas make it possible to carry out a liquefaction process generally comprising the following three stages:

1. A “pretreatment” which removes, from the natural gas to be liquefied, the impurities liable to freeze (H₂O, CO₂, sulfur-comprising derivatives, mercury, and the like);

2. Extraction of the heavy hydrocarbons and aromatic derivatives which may freeze during the liquefaction. This stage can take place upstream of or in parallel with the liquefaction;

3. Liquefaction by cooling of the natural gas to a cryogenic temperature (typically −160° C.) by virtue of a refrigerating cycle and optionally also accompanied by a withdrawal of the heavy hydrocarbons/aromatic derivatives liable to freeze.

### SUMMARY

The inventors of the present invention have developed a solution enabling a recycling of streams resulting from the natural gas liquefaction unit to the fuel system of the generating process. This integration between the two processes exhibits numerous advantages of synergies.

A subject-matter of the present invention is a process for the liquefaction of natural gas in combination with a process for the production of synthesis gas, the liquefaction process comprising the following stages:
Stage a): pretreatment of a feed natural gas in order to remove the impurities liable to freeze during the liquefaction process by means (i) of a pretreatment system also using a regeneration stream;
Stage b): extraction, from the gas stream resulting from stage a), of a stream enriched in hydrocarbons having more than two carbon atoms and of a stream depleted in hydrocarbons having more than two carbon atoms;
Stage c): liquefaction of the gas stream depleted in hydrocarbons having more than two carbon atoms resulting from stage b);

the process for the production of synthesis gas comprising the following stages:
Stage a′): desulfurization at a temperature of greater than 350° C. of a natural gas feed stream;
Stage b′): optional prereforming, at a temperature of greater than 500° C., in order to convert the hydrocarbon chains containing at least two carbon atoms of the gas stream resulting from stage a′) into methane;
Stage c′): reforming consisting in reacting, at a temperature of greater than 800° C., the gas stream resulting from stage a′) or b′) with steam in order to produce hydrogen, carbon dioxide and carbon monoxide;

characterized in that at least a portion of the heat source required for the synthesis gas production process is produced by at least a portion of the regeneration stream used during stage a).
The pretreatment system used in stage a) may be an adsorption separation system using a regeneration stream or an amine scrubbing system followed downstream by a drying unit, this drying unit also using a regeneration stream.

According to other embodiments, the invention also relates to:
A process as defined above, characterized in that stage a) consists of a pretreatment by adsorption by means of an adsorption system comprising between two and five containers of at least one layer of adsorbent and at least one device for heating and/or cooling an adsorption and/or regeneration stream circulating in said adsorption system.
A process as defined above, characterized in that, during stage a′), all the sulfur-comprising derivatives present in the feed gas are converted into H₂S by catalysis in a reactor.
A process as defined above, characterized in that the product H₂S is extracted by catalysis.
A process as defined above, characterized in that the impurities liable to freeze during the liquefaction process which are removed during stage a) comprise the water, the carbon dioxide and the sulfur-comprising derivatives present in the feed gas.
A process as defined above, characterized in that, during stage c), the stream of natural gas depleted in hydrocarbons having more than two carbon atoms resulting from stage b) is liquefied at a temperature of less than −140° C. by means of a unit for the liquefaction of natural gas comprising at least one main heat exchanger and a system for producing frigories.
A process as defined above, characterized in that the natural gas feed stream employed in stage a) and the natural gas feed stream employed in stage a′) originate from one and the same natural gas feed stream.
A process as defined above, characterized in that the unit for the production of synthesis gas is a unit for the production of hydrogen by steam reforming having a hydrogen production capacity of at least 20 000 Nm³/h.
A process as defined above, characterized in that from 5% to 35% (preferably from 10% to 20%) of the amount of fuel of the heat source required for the synthesis gas production process is produced by at least a portion of the regeneration stream used during step a).
Process as defined above, characterized in that the regeneration stream used during stage a) leads to an excess of the fuel balance of the synthesis gas production unit and is sent back to the feed stream of the synthesis gas production unit.

Furthermore, if the pressure of the regeneration gas is greater than the pressure of the fuel network, it is possible to do without compressors/rotating machines, which represents a significant saving regarding the cost of the natural gas liquefaction unit.

The stream of hydrocarbons to be liquefied is generally a stream of natural gas obtained from a domestic gas network in which the gas is distributed via pipelines.

The expression “natural gas” as used in the present patent application relates to any composition containing hydrocarbons, including at least methane. This comprises a “crude” composition (prior to any treatment or scrubbing) and also any composition which has been partially, substantially or completely treated for the reduction and/or removal of one or more compounds, including, but without being limited thereto, sulfur, carbon dioxide, water, mercury and certain heavy and aromatic hydrocarbons.

The heat exchanger can be any heat exchanger, any unit or other arrangement suitable for making possible the passage of a certain number of streams, and thus making possible a direct or indirect exchange of heat between one or more refrigerant fluid lines and one or more feed streams. Generally, the natural gas stream is essentially composed of methane,

Preferably, the feed stream comprises at least 80 mol % of methane. Depending on the source, the natural gas contains quantities of hydrocarbons heavier than methane, such as, for example, ethane, propane, butane and pentane and also certain aromatic hydrocarbons. The natural gas stream also contains nonhydrocarbon products, such as nitrogen (content variable but of the order of 5 mol %, for example) or other impurities H₂O, CO₂, H₂S and other sulfur-comprising compounds, mercury and others (0.5 mol % to 5 mol % approximately).

The feed stream containing the natural gas is therefore pretreated before being introduced into the heat exchanger. This pretreatment comprises the reduction and/or the removal of the undesirable components, such as, generally, CO₂ and H₂O but also H₂S and other sulfur-comprising compounds or mercury.

In order to prevent the latter from freezing during the liquefaction of the natural gas and/or the risk of damage to the items of equipment located downstream (by corrosion phenomena, for example), it is advisable to remove them.

One means which makes it possible to remove the CO₂ from the natural gas stream is, for example, amine scrubbing which is located upstream of a liquefaction cycle.

Amine scrubbing separates the CO₂ from the feed gas by scrubbing the natural gas stream with a solution of amines in an absorption column. The solution of amines enriched in CO₂ is recovered in the bottom of this absorption column and is regenerated at low pressure in a column for regeneration of the amine (or stripping column).

An alternative to the amine scrubbing treatment may be pressure swing and/or temperature swing adsorption. The advantages of such a process are described below.

This separation process makes use of the fact that, under certain pressure and temperature conditions, some constituents of the gas (CO₂ and H₂O in particular) have specific affinities with regard to a solid material, the adsorbent (for example molecular sieves).

The adsorption is a reversible process and it is possible to regenerate the adsorbent by lowering the pressure and/or raising the temperature of the adsorbent in order to release the adsorbed constituents of the gas.

Thus, in practice, an adsorption separation system consists of several (between two and five) “cylinders” containing one or more layers of adsorbents and also appliances dedicated to the heating/cooling of the adsorption and/or regeneration stream.

In comparison with a conventional amine scrubbing, the pretreatment has a certain number of advantages.
its cost;
its simplicity of operation;
the possibility of avoiding a certain number of services (makeup of amine or of distilled water).

These advantages are particularly significant for small-sized units for the liquefaction of natural gas (for example producing less than 50 000 tonnes of liquefied natural gas per year).

An exemplary embodiment is illustrated by the following example.

The production of hydrogen by catalytic reforming requires a continuous supply of heat provided by a fuel gas network.

A steam reforming unit with a nominal hydrogen production capacity of approximately 130 000 Nm³/h is employed.

The heat requirements needed for the hydrogen production unit are mainly provided (about 75%) by the residual gas resulting from the last stage of purification of hydrogen in the hydrogen production unit (purification via molecular sieves (Pressure Swing Adsorption/PSA)). The makeup (about 25%) is provided by a source external to the hydrogen production unit (for example originating from the feed stream of the unit or from an external fuel system).

By placing a small natural gas production unit with a capacity of 40 000 tonnes of liquefied natural gas produced per year close to the hydrogen production unit, it is possible to return certain flows to the fuel network of the hydrogen production unit. The makeup provided by an external source will be reduced accordingly.
In the case where the pretreatment of the natural gas is provided by an adsorption process, the regeneration gas returned to the fuel network would represent about 15% of the fuel balance.
The heavy hydrocarbons extracted from the natural gas liquefier and the natural gas vapors generated in the storage of liquefied natural gas and/or in the loading bay will be less significant in the fuel balance (less than 1%).

The external heat source makeup is thus reduced from 25% to 10% approximately.

This integration makes it possible to drastically reduce the number of pieces of equipment dedicated to secondary streams of the natural gas liquefaction unit:
heavy hydrocarbons: the integration makes it possible, for example, to avoid having an incinerator and/or a system for extracting heavy hydrocarbons which is expensive for small-sized units.
natural gas vapors generated in the storage of liquefied natural gas and/or in the loading bay: the integration makes it possible for example to avoid having a compressor to recycle these vapors into the natural gas liquefaction stream. This compressor may be expensive in small-sized liquefiers.

If the capacity of the liquefied natural gas production unit unbalances the fuel balance, it is possible to return all or part of these streams to the synthesis gas stream that feeds the hydrogen production unit (at the cost of a compressor).

It is then possible for the units for the production of synthesis gas and for the liquefaction of natural gas to have in common all of the conveniences of the site, in particular:
The connection to the natural gas network;
The metering and optionally pressure reduction/compression station;
A hot flare and optionally cold liquid network;
All of the utilities of the site (electricity, cooling circuit, instrumentation air, nitrogen, and the like);
The feed network.

Furthermore, in the case where the unit for the production of synthesis gas produces hydrogen, it is sometimes required to liquefy all or part of the hydrogen in order to facilitate the transportation or storage thereof, for example.

In this case, it is possible to “precool” the hydrogen produced in the natural gas liquefier down to a temperature of −160° C., for example, and then to finish liquefying it in a dedicated unit.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-12. (canceled)

13. A process for the liquefaction of natural gas in combination with a process for the production of synthesis gas, the liquefaction process comprising:
a) pretreating a feed natural gas by means of a pretreatment system using a regeneration stream, to remove impurities that will freeze during the liquefaction process, thereby producing a pretreated stream;
b) extracting a stream enriched in hydrocarbons having more than two carbon atoms and of a stream depleted in hydrocarbons having more than two carbon atoms from the pretreated stream, thereby producing a hydrocarbon enriched stream;
c) liquefying of the hydrocarbon enriched stream;
the process for the production of synthesis gas comprising:
a′) desulfurizing a natural gas feed stream at a temperature of greater than 350° C., thereby producing a desulfurized stream;
b′) prereforming the hydrocarbon chains containing at least two carbon atoms in the desulfurized stream into methane at a temperature of greater than 500° C., thereby producing a prereformed stream;
c′) reforming the desulfurized stream or the prereformed stream with steam at a temperature of greater than 800° C. in order to produce hydrogen, carbon dioxide and carbon monoxide;
wherein at least a portion of the heat source required for the synthesis gas production process is produced by at least a portion of the regeneration stream.

14. The process as claimed in claim 13, wherein the pretreating is performed by an adsorption separation system.

15. The process as claimed in claim 13, wherein the pretreating is performed by an amine scrubbing system followed downstream by a drying unit, the drying unit comprising the regeneration stream.

16. The process as claimed in claim 14, wherein step a) consists of pretreating by adsorption by means of an adsorption system comprising between two and five containers of at least one layer of adsorbent and at least one device for heating and/or cooling an adsorption and/or regeneration stream circulating in the adsorption system and wherein the steam resulting from the process for the production of synthesis gas is employed to reheat the regeneration stream.

17. The process as claimed in claim 13, wherein, during step a′), all sulfur-comprising derivatives present in the feed gas are converted into H₂S product by catalysis in a reactor.

18. The process as claimed in claim 17, wherein the product H₂S is extracted by catalysis.

19. The process as claimed in claim 13, wherein the impurities that will freeze during the liquefaction process which are removed during step a) comprise water, carbon dioxide and sulfur-comprising derivatives present in the feed natural gas.

20. The process as claimed in claim 13, wherein during step c), the hydrocarbon enriched stream is liquefied at a temperature of less than −140° C. by means of a unit for the liquefaction of natural gas comprising at least one main heat exchanger and a system for producing frigories.

21. The process as claimed in claim 13, wherein the natural gas feed stream employed in step a) and the natural gas feed stream employed in step a′) originate from the same natural gas feed stream.

22. The process as claimed in claim 13, wherein the unit for the production of synthesis gas is a unit for the production of hydrogen by steam reforming has a hydrogen production capacity of at least 20 000 Nm³/h.

23. The process as claimed in claim 13, wherein the heat energy of the regeneration stream used during step a) represents from 5% to 35 of the amount of fuel required for the synthesis gas production process.

24. The process as claimed in claim 13, wherein the regeneration stream used during step a) produces an excess of the fuel balance of the synthesis gas production unit and is sent back to the feed stream of the synthesis gas production unit.
